(19) United States
(12) Patent Application Publication
(10) Pub. No.: US 2026/0112725 A1
(43) Pub. Date: Apr. 23, 2026

(54) PORTABLE ENERGY STORAGE DEVICE AND METHOD FOR DYNAMICALLY ADJUSTING POWER BASED ON INTERNAL TEMPERATURE

(71) Applicant: Ningbo Soyar Technology Innovation Co., Ltd., Ningbo (CN)

(72) Inventor: Tao HUANG, Ningbo (CN)

(73) Assignee: Ningbo Soyar Technology Innovation Co., Ltd., Ningbo (CN)

(21) Appl. No.: 19/271,164

(22) Filed: Jul. 16, 2025

(30) Foreign Application Priority Data
Sep. 6, 2024 (CN) 202411250982X

(51) Int. Cl. H01M 10/637; H01M 10/617; H01M 10/623

(52) U.S. Cl. CPC H01M 10/637; H01M 10/617; H01M 10/623

(57) ABSTRACT

The present invention provides a portable energy storage device and method that dynamically adjusts power based on internal temperature, based on the battery pack temperature model data, which allocates corresponding decision power at each critical decision point temperature. During the use of the energy storage device, when the power is reduced due to the increase in the battery pack temperature, if the power reduction causes the temperature to be in a decreasing stage, then during the temperature-decreasing process, the control unit will not restore the battery pack to a larger power until the temperature decrease magnitude exceeds the hysteresis temperature threshold. The present invention allows the power of the battery pack to be adjusted according to its real-time temperature, ensuring the operational safety of the device while maintaining the power at a high level. Additionally, the design of the hysteresis temperature threshold enhances the operational stability of the device.

### TECHNICAL FIELD

The present invention relates to the field of energy storage technology, and specifically, to a portable energy storage device and method for dynamically adjusting power based on internal temperature.

### BACKGROUND TECHNOLOGY

With the widespread use of mobile devices and the increase in outdoor activities, the demand for portable energy storage devices has been growing. Whether for outdoor camping, emergency power needs, or daily charging of mobile devices, portable energy storage devices that provide reliable power have become indispensable tools. The application scenarios for portable energy storage devices are extensive, and user demands for functional diversity and convenience continue to rise.

Traditional portable energy storage devices typically offer fixed channel power, which cannot meet the need for dynamically adjusting power based on the internal temperature of the device. Although some prior patents have proposed the concept of linking the temperature of portable energy storage devices to power adjustments, these inventions focus on adjusting power to control the temperature of the power source. For example, when the device detects that the temperature has reached a threshold, it reduces the output power or disconnects the output. While this method can protect the power source from damage, the instantaneous reduction in output power significantly impacts connected devices and prevents the device from maintaining a high power output, negatively affecting user experience. For instance, the prior patent with publication number CN117118039B discloses an over-temperature protection method, device, and system for outdoor mobile power sources. It first determines the temperature rise rate and time of the power source components through temperature detection, as well as the operating time of the mobile power source during charging or discharging. When the operating time exceeds the temperature rise time, it calculates the suppressed temperature rise of the power source components within the temperature rise time, determines the target power change based on a predefined mapping relationship between suppressed temperature rise and power change, and finally reduces the input or output power of the mobile power source according to the target power change, thereby protecting the power source.

Additionally, existing portable energy storage devices often feature multiple charging output interfaces. However, when multiple high-load devices are simultaneously connected to these interfaces, existing portable energy storage devices fail to allocate appropriate power to each channel reasonably. This can lead to device damage due to overload or high temperatures during operation.

### SUMMARY OF THE INVENTION

To address the shortcomings of the prior art, the objective of the present invention is to provide a portable energy storage device and method for dynamically adjusting power based on internal temperature. Through an ingenious design, the power of the battery pack and power channels can be adjusted according to their real-time temperature, ensuring the operational safety of the device while maintaining a high power output. Furthermore, the design of the hysteresis temperature threshold enhances the operational stability of the device.

To achieve the above objective, the present invention provides the following technical solutions.

According to the first aspect of the present invention, a portable energy storage device that dynamically adjusts power based on internal temperature is provided, comprising a battery pack, a first temperature sensor, and a control unit, the first temperature sensor is used to detect the real-time temperature of the battery pack, and the control unit can set the real-time allowable power of the battery pack based on the real-time temperature of the battery pack fed back by the first temperature sensor; the control unit has a built-in pre-configured temperature model for the battery pack, defined as model Mbat, in model Mbat, N critical decision point temperatures with gradually increasing values are set, defined as Tb_D₁, Tb_D₂, . . . , Tb_D_{N}, and N decision powers with gradually decreasing values corresponding one-to-one to the critical decision point temperatures, defined as Tb_P₁, Tb_P₂, . . . , Tb_P_{N}, and N hysteresis temperature thresholds corresponding one-to-one to the decision powers, defined as Tb_H₁, Tb_H₂, . . . , Tb_H_{N}, Tb is defined as the real-time temperature of the battery pack, Ps is defined as the real-time allowable power of the battery pack decided by the control unit, and Tb_min is defined as the minimum value of the allowable operating temperature range of the battery pack, when N≥3:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_Dₖ due to temperature rise and is within the range of Tb_Dₖ<Tb≤Tb_Dₖ₊₁, the control unit sets Ps=Tb_Pₖ₊₁, where k takes values from 1 to N−1;
when power recovery triggered by a temperature decrease in the battery pack is involved: if Tb decreases from a temperature higher than Tb_Dₖ₊₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2;
if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D_{N}, the control unit disables the charging and discharging functions of the battery pack;
when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N.

Preferably, when N=2:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved: if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack;
when Tb decreases from a temperature higher than Tb_D₂ to (Tb_D₂−Tb_H₂), Tb_Dₐ is defined as the critical decision point temperature that is the closest to and greater than or equal to (Tb_D₂−Tb_H₂), if Tb_Dₐ is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.

Preferably, the energy storage device further comprises at least two power channels and a corresponding number of second temperature sensors, with the second temperature sensors individually installed in the power channels to detect the real-time temperature of each power channel; the control unit can set the real-time allowable power of each power channel based on the real-time temperature of the power channel fed back by the second temperature sensors;
the control unit also has a built-in pre-configured temperature model for each power channel, defined as model Mn, in each model Mn, n critical decision point temperatures with gradually increasing values are set, defined as Tc_D₁, Tc_D₂, . . . , Tc_Dₙ, and n decision powers with gradually decreasing values corresponding one-to-one to the critical decision point temperatures, defined as Tc_P₁, Tc_P₂, . . . , Tc_Pₙ, and n hysteresis temperature thresholds corresponding one-to-one to the decision powers, defined as Tc_H₁, Tc_H₂, . . . , Tc_Hₙ; Tc is defined as the real-time temperature of any power channel, Pc is defined as the real-time allowable power of the channel decided by the control unit, and Tc_min is defined as the minimum value of the allowable operating temperature range of the channel; when n≥3:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_Dₖ due to temperature rise and is within the range of Tc_Dₖ<Tc≤Tc_Dₖ₊₁, the control unit sets Pc=MIN{Tc_Pₖ₊₁, (Ps−total power allocated to other channels)}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, (Ps−total power allocated to other channels)}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, (Ps−total power allocated to other channels)};
when Tc exceeds Tc_Dₙ, the control unit disables the charging/discharging function of the power channel;
when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, (Ps−total power allocated to other channels)}, where 1≤a≤n.

Preferably, when n=2:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_D₁ due to temperature rise and is within the range of Tc_D₁<Tc≤Tc_D₂, the control unit sets Pc=MIN{Tc_P₂, (Ps−total power allocated to other channels)};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, (Ps−total power allocated to other channels)};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Da, if Tc_Da is Tc_D₁, the control unit restores the charging/discharging function of the power channel and sets Pc=MIN{Tc_P₁, (Ps−total power allocated to other channels)}; if Tc_Da is Tc_D₂, the control unit restores the charging/discharging function of the power channel and sets Pc=MIN{Tc_P₂, (Ps−total power allocated to other channels)}.

Preferably, the device further comprises a power channel and a second temperature sensor, with the second temperature sensor installed in the power channel to detect the real-time temperature of the power channel; the control unit can set the real-time allowable power of the power channel based on the real-time temperature of the power channel fed back by the second temperature sensor;
the control unit also has a built-in pre-configured temperature model for the power channel, defined as model M1, in model M1, n critical decision point temperatures with gradually increasing values are set, defined as Tc_D₁, Tc_D₂, . . . , Tc_Dₙ, and n decision powers with gradually decreasing values corresponding one-to-one to the critical decision point temperatures, defined as Tc_P₁, Tc_P₂, . . . , Tc_Pₙ, and n hysteresis temperature thresholds corresponding one-to-one to the decision powers, defined as Tc_H₁, Tc_H₂, . . . , Tc_Hₙ; Tc is defined as the real-time temperature of the power channel, Pc is defined as the real-time allowable power of the channel decided by the control unit, and Tc_min is defined as the minimum value of the allowable operating temperature range of the channel; when n≥3:
when power recovery triggered by a temperature decrease in the power channel is not involved:
if Tc is within the range of Tc_min≤Tc≤Tc_D₁, the control unit sets Pc=MIN{Tc_P₁, Ps};
if Tc exceeds Tc_Dₖ due to temperature rise and is within the range of Tc_Dₖ<Tc≤Tc_Dₖ₊₁, the control unit sets Pc=MIN{Tc_Pₖ₊₁, Ps}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, Ps}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_Dₙ, the control unit disables the charging/discharging function of the power channel;
when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, Ps}, where 1≤a≤n.

Preferably, when n=2:
when power recovery triggered by a temperature decrease in the power channel is not involved:
if Tc is within the range of Tc_min≤Tc≤Tc_D₁, the control unit sets Pc=MIN{Tc_P₁, Ps}; if Tc exceeds Tc_D₁ due to temperature rise and is within the range of Tc_D₁<Tc≤Tc_D₂, the control unit sets Pc=MIN{Tc_P₂, Ps};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, Ps};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Dₐ, if Tc_Dₐ is Tc_D₁, the control unit restores the charging/discharging function of the power channel and sets Pc=MIN{Tc_P₁, Ps}, if Tc_Dₐ is Tc_D₂, the control unit restores the charging/discharging function of the power channel and sets Pc=MIN{Tc_P₂, Ps}.

Preferably, when the power channel is a charging channel, the allowable power of the battery pack is the allowable input power; when the power channel is a discharging channel, the allowable power of the battery pack is the allowable output power.

Preferably, the portable energy storage device is internally equipped with a main control board and one or more independent circuit boards connected to the main control board; the circuit boards are provided with interfaces for charging/discharging, each interface corresponding to a power channel; the main control board is embedded with an intelligent control chip, and the control unit is implemented on the intelligent control chip.

Preferably, the control unit constructs a temperature variation curve by reading the voltage, current, temperature of the power channels, and the temperature of the battery pack from each interface, and adjusts the charging/discharging power of each interface accordingly.

According to the second aspect of the present invention, a method for dynamically adjusting power based on internal temperature is provided, which is applied to the portable energy storage device according to any one of the first aspect of the present invention, the method comprising a battery pack power adjustment method, wherein the battery pack power adjustment method is as follows:
when N≥3:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_Dₖ due to temperature rise and is within the range of Tb_Dₖ<Tb≤Tb_Dₖ₊₁, the control unit sets Ps=Tb_Pₖ₊₁, where k takes values from 1 to N−1;
when power recovery triggered by a temperature decrease in the battery pack is involved:
if Tb decreases from a temperature higher than Tb_Dₖ₊₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2;
if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D_{N}, the control unit disables the charging and discharging functions of the battery pack;
when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N;
when N=2:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved: if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack;
when Tb decreases from a temperature higher than Tb_D₂ to (Tb_D₂−Tb_H₂), Tb_Dₐ is defined as the critical decision point temperature that is the closest to and greater than or equal to (Tb_D₂−Tb_H₂), if Tb_Dₐ is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.

Preferably, the method comprises a power adjustment method for the power channels. when the number of power channels is ≥2, the power adjustment method for the power channels is as follows:
when n≥3:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_Dₖ due to temperature rise and is within the range of Tc_Dₖ<Tc≤Tc_Dₖ₊₁, the control unit sets Pc=MIN{Tc_Pₖ₊₁, (Ps−total power allocated to other channels)}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, (Ps−total power allocated to other channels)}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, (Ps−total power allocated to other channels)};
when Tc exceeds Tc_Dₙ, the control unit disables the charging/discharging function of the power channel;
when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, (Ps−total power allocated to other channels)}, where 1≤a≤n;
when n=2:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_D₁ due to temperature rise and is within the range of Tc_D₁<Tc≤Tc_D₂, the control unit sets Pc=MIN{Tc_P₂, (Ps−total power allocated to other channels)};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, (Ps−total power allocated to other channels)};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Dₐ, if Tc_Da is Tc_D₁, the control unit restores the charging/discharging function of the power channel and sets Pc=MIN{Tc_P₁, (Ps−total power allocated to other channels)}; if Tc_Da is Tc_D₂, the control unit restores the charging/discharging function of the power channel and sets Pc=MIN{Tc_P₂, (Ps−total power allocated to other channels)}.

Preferably, the method comprises a power adjustment method for the power channel. when the number of power channels is 1, the power adjustment method for the power channel is as follows:
when n≥3:
when power recovery triggered by a temperature decrease in the power channel is not involved:
if Tc is within the range of Tc_min≤Tc≤Tc_D₁, the control unit sets Pc=MIN{Tc_P₁, Ps};
if Tc exceeds Tc_Dₖ due to temperature rise and is within the range of Tc_Dₖ<Tc≤Tc_Dₖ₊₁, the control unit sets Pc=MIN{Tc_Pₖ₊₁, Ps}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, Ps}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_Dₙ, the control unit disables the charging/discharging function of the power channel; when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, Ps}, where 1≤a≤n.
when n=2:
when power recovery triggered by a temperature decrease in the power channel is not involved:
if Tc is within the range of Tc_min≤Tc≤Tc_D₁, the control unit sets Pc=MIN{Tc_P₁, Ps};
if Tc exceeds Tc_D₁ due to temperature rise and is within the range of Tc_D₁<Tc≤Tc_D₂, the control unit sets Pc=MIN{Tc_P₂, Ps};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, Ps};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Dₐ, if Tc_Da is Tc_D₁, the control unit restores the charging/discharging function of the power channel and sets Pc=MIN{Tc_P₁, Ps}; if Tc_Dₐ is Tc_D₂, the control unit restores the charging/discharging function of the power channel and sets Pc=MIN{Tc_P₂, Ps}.

Compared with the existing technology, the present invention has the following beneficial effects:

The portable energy storage device and method for dynamically adjusting power based on internal temperature provided by the present invention, through an ingenious design, enable the battery pack and, further, the power of the power channels to be adjusted according to their real-time temperature. This ensures the operational safety of the device while maintaining the power at a high level. Additionally, the design of the hysteresis temperature threshold enhances the operational stability of the device.

### DESCRIPTION OF THE DRAWINGS

By referring to the following detailed description of non-limiting embodiments with reference to the accompanying drawings, other features, objectives, and advantages of the present invention will become more apparent:

FIG. 1 is the schematic diagram of the portable energy storage device for dynamically adjusting power based on internal temperature; in this figure, the number of power channels is 3.

FIG. 2 illustrates the power adjustment logic for dynamically adjusting power based on the internal temperature of the portable energy storage device.

### DETAILED DESCRIPTION OF EMBODIMENTS

To make the objectives, technical solutions, and advantages of the embodiments of the present invention clearer, the technical solutions in the embodiments of the present invention will be described clearly and completely in conjunction with the accompanying drawings. Obviously, the described embodiments are part of the embodiments of the present invention, rather than all embodiments. The components of the embodiments of the present invention described and shown in the accompanying drawings can generally be arranged and designed in various configurations.

Therefore, the following detailed description of the embodiments of the present application provided in the accompanying drawings is not intended to limit the scope of the claimed application but merely represents selected embodiments of the present invention. Based on the embodiments of the present application, all other embodiments obtained by those of ordinary skill in the art without inventive efforts shall fall within the scope of protection of the present application.

It should be noted that the descriptions of “first”, “second”, etc. in the present invention are for descriptive purposes only and should not be construed as indicating or implying relative importance or implicitly specifying the quantity of the indicated technical features.

### Embodiment 1

This embodiment provides a portable energy storage device for dynamically adjusting power based on internal temperature, suitable for various scenarios such as outdoor camping, emergency power supply, and mobile device charging. Structurally, the energy storage device is made of lightweight and high-strength shell materials, with one or more independent circuit boards inside. The circuit boards are equipped with charging interfaces and discharging interfaces, each corresponding to a power channel. The circuit boards are connected to the main control board via wires, and the main control board is embedded with an intelligent control chip, which includes a control unit for executing power allocation algorithms. The control unit calculates temperature change curves by reading parameters such as current, voltage, temperature of each power channel, and battery temperature, and adjusts the charging/discharging power of each interface accordingly. Additionally, the portable energy storage device includes a safety protection algorithm. When the temperature of a certain part exceeds the normal operating range or the temperature change rate is abnormal, the control unit will reduce the power of the corresponding power channel or shut down the power channel to ensure the safety of the device.

Specifically, the portable energy storage device provided in this embodiment comprises the following components:

(1) One battery pack and at least two power channels whose power is determined based on temperature.

(2) Each power channel and the battery pack are equipped with temperature sensors. The temperature sensors are used to detect the temperature of the channels and the battery pack in real time. For distinction, the temperature sensor detecting the battery pack is defined as the first temperature sensor, and the temperature sensor detecting the power channels is defined as the second temperature sensor.

(3) An MCU chip, which includes a control unit. The control unit can collect the temperature information of each power channel and the battery pack fed back by the first and second temperature sensors, adjust the allowable total power of the battery pack based on the temperature values, and adjust the allowable allocated power of each power channel within the limit of the allowable total power of the battery pack, thereby achieving the function of automatic power adjustment based on temperature.

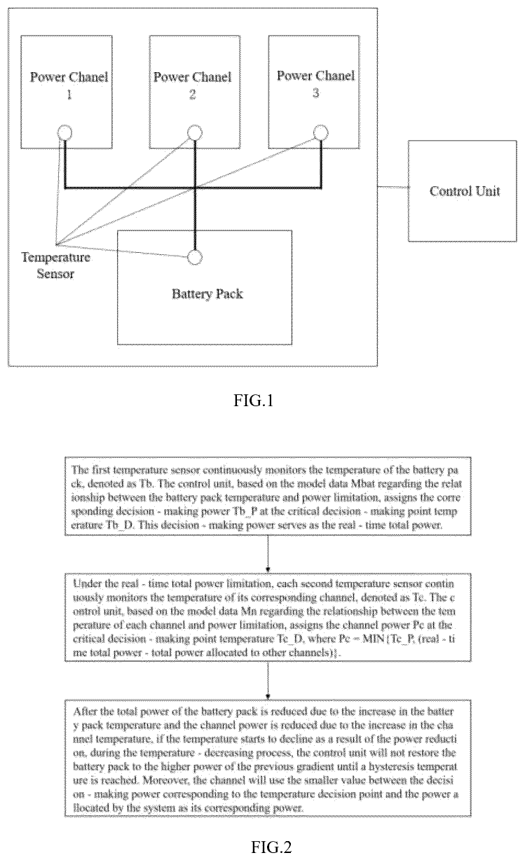

FIG. 1 shows the schematic diagram of the portable energy storage device when the number of power channels is 3.

It should be noted that the power channels referred to in present invention are channels whose power is determined based on temperature. They can be charging channels or discharging channels. That is, the rules for dynamically adjusting power based on temperature in present invention are applicable to both charging channels and discharging channels (Note: Charging channels refer to channels used for charging the portable energy storage device itself, while discharging channels refer to channels used for charging other devices using the portable energy storage device). When the power channel is a charging channel, the allowable total power of the battery pack refers to the allowable total input power, and the control unit makes decisions on the allowable allocated input power of each charging channel within the limit of the allowable total input power. When the power channel is a discharging channel, the allowable total power of the battery pack refers to the allowable total output power, and the control unit makes decisions on the allowable allocated output power of each discharging channel within the limit of the allowable total output power.

Furthermore, the allowable power of the battery pack is relative to the actual operating power. The allowable power refers to the maximum power that the control unit decides the battery pack can operate at, and the actual operating power of the battery pack can be below the allowable power. Similarly, the allowable power of a channel is also relative to the actual operating power. The allowable power refers to the maximum power that the control unit decides the channel can operate at, and the actual operating power of the channel can be below the allowable power. For example, if the control unit decides that the allowable output power of a discharging channel is 30 W, but the request power of the discharging channel is only 10 W, then the actual operating power of the discharging channel is 10 W, which is less than the allowable output power. The power dynamically adjusted based on temperature in the present invention refers to the allowable power, not the actual operating power.

The definitions of related concepts in this embodiment are as follows:

The real-time temperature of the battery pack detected by the first temperature sensor is defined as Tb. The control unit has a built-in pre-configured temperature curve model for the battery pack, defined as model Mbat. On the model Mbat, N (N≥3) critical decision point temperatures with gradually increasing values are set, defined as Tb_D₁, Tb_D₂, . . . , Tb_D_{N}. Each critical decision point temperature corresponds to a decision power, and the decision powers corresponding to these critical decision point temperatures are defined as Tb_P₁. Tb_P₂ . . . . Tb_P_{N}, respectively. In model Mbat, temperature and power have an inverse relationship, so the values of these decision powers gradually decrease, where Tb_P₁ is the maximum threshold of the decision powers. Furthermore, each decision power corresponds to a hysteresis temperature threshold for power recovery, and these hysteresis temperature thresholds are defined as Tb_H₁, Tb_H₂ . . . . Tb_H_{N}, respectively.

It should be noted that the values of the N critical decision point temperatures gradually increase, which can be in equal increments or varying increments. Correspondingly, the values of the decision powers gradually decrease, which can be in equal decrements or varying decrements. As for the hysteresis temperature thresholds, the values of the N hysteresis temperature thresholds can be the same or different. Additionally, the minimum value of the battery pack's operating temperature range is defined as Tb_min, where Tb_D1>Tb_min. For Tb_H₁, Tb_H₁≤(Tb_D₁−Tb_min). For Tb_H₂ to Tb_H_{N-1}, each should be less than or equal to the difference between the corresponding adjacent critical decision point temperatures. For example, for Tb_H₂, Tb_H₂≤(Tb_D₂−Tb_D₁); for Tb_H₃, Tb_H₃≤(Tb_D₃−Tb_D₂); for Tb_H₄, Tb_H₄≤(Tb_D₄−Tb_D₃), and so on. As for Tb_H_{N}, its value is not strictly limited and can be either≤(Tb_D_{N}−Tb_D_{N-1}) or > (Tb_D_{N}−Tb_D_{N-1}).

There are multiple power channels (in this embodiment, the number of power channels is at least two). For any power channel, the second temperature sensor installed within it detects the real-time temperature of the channel, defined as Tc. The control unit has a built-in pre-configured temperature curve model for this channel, defined as model Mn, which features n (n≥3) critical decision point temperatures with gradually increasing values, defined as Tc_D₁, Tc_D₂ . . . . Tc_Dₙ. Each critical decision point temperature corresponds to a decision power, and these decision powers corresponding to the critical decision point temperatures are defined as Tc_P₁, Tc_P₂, . . . , Tc_Pn. In model Mn, there is an inverse relationship between temperature and power, hence the values of these decision powers gradually decrease, with Tc_P₁ being the maximum threshold of the decision powers. Furthermore, each decision power corresponds to a hysteresis temperature threshold for power recovery, and these hysteresis temperature thresholds are defined as Tc_H₁, Tc_H₂, . . . , Tc_Hn.

It should be noted that for multiple power channels, their temperature curve models can be the same or different. When the preset allowable power of two power channels is different, their temperature curve models can also differ. For example, if the maximum allowable output power of discharge channel A is preset to 30 W and that of discharge channel B is preset to 100 W, the actual operating power of channel A will always be less than or equal to 30 W, therefore, the temperature change of channel A during operation may be small, while the actual operating power of channel B is higher than that of channel A, and its temperature change during operation may be more significant. In this case, the number of critical decision point temperatures in the temperature curve model of channel A can be set to be fewer than that of channel B. For example, the temperature curve model of channel A may have 5 critical decision point temperatures, while that of channel B may have 10.

Additionally, for the temperature curve model of each power channel, the values of the n critical decision point temperatures gradually increase, which can be in equal increments or varying increments. Correspondingly, the values of the decision powers gradually decrease, which can be in equal decrements or varying decrements. As for the hysteresis temperature thresholds, the values of multiple hysteresis temperature thresholds can be the same or different. Furthermore, the minimum value of the operating temperature range of the power channel is defined as Tc_min. For Tc_H₁, Tc_H₁≤(Tc_D₁−Tc_min). For Tc_H₂ to Tc_Hₙ₋₁, each should be less than or equal to the difference between the corresponding adjacent critical decision point temperatures. For example, for Tc_H₂, Tc_H₂≤(Tc_D₂−Tc_D₁); for Tc_H₃, Tc_H₃≤(Tc_D₃−Tc_D₂), and so on. As for Tc_Hn, its value is not strictly limited and can be either≤(Tc_Dₙ−Tc_Dₙ₋₁) or > (Tc_Dₙ−Tc_Dₙ₋₁).

The portable energy storage device provided in this embodiment, which can dynamically adjust power based on the internal temperature of the device, has the overall power adjustment logic as shown in FIG. 2:

(1) The first temperature sensor detects the real-time temperature Tb of the battery pack, and the control unit allocates the corresponding decision power Tb_P based on the model Mbat of the relationship between the battery pack temperature and power limit at the critical decision point temperature Tb_D, this decision power is the real-time allowable total power.

(2) Under the limit of the real-time allowable total power, each second temperature sensor detects the real-time temperature (defined as Tc) of its corresponding channel, the control unit allocates the channel power (defined as Pc) based on the channel temperature and power limit model Mn at the critical decision point temperature (defined as Tc_D), where Pc=MIN{Tc_P, (real-time allowable total power−total power allocated to other channels)}. Here, MIN{Tc_P, (real-time allowable total power−total power allocated to other channels)} refers to the smaller value between Tc_P and (real-time allowable total power−total power allocated to other channels), where Tc_P is defined as the channel decision power at the corresponding critical decision point temperature, and the real-time allowable total power is the power at the critical decision point temperature corresponding to the current real-time temperature of the battery pack.

(3) During the use of the portable energy storage device, if the increase in the battery pack temperature triggers a reduction in the real-time allowable total power of the battery pack, or if the increase in the channel temperature triggers a reduction in the real-time allowable allocated power of the channel, and if the power reduction causes the temperature to enter a decreasing phase, then during the temperature decrease process, the control unit will restore the battery pack to the previous higher allowable power only after the temperature drop exceeds the hysteresis temperature threshold. The channel's allowable power is determined by the minimum value between the decision power corresponding to the critical decision point temperature and the allocated power of the system.

During decision-making, the priority of the relevant models is as follows: model Mbat>model Mn, meaning the control unit first decides the allowable total power of the battery pack based on its temperature, and then, under the limit of the battery pack's allowable total power, decides the allowable allocated power of each power channel. Each power channel has the same priority for power decision-making based on temperature.

The specific scheme for battery pack power adjustment in this embodiment is as follows, where Tb is the real-time temperature of the battery pack, Ps is the real-time allowable total power of the battery pack decided by the control unit, and Tb_min is the minimum value of the battery pack's allowable operating temperature range:
1. If power recovery triggered by a decrease in the battery pack temperature is not involved: (1) If Tb is within the range of Tb_min≤Tb≤Tb_D₁, the control unit sets Ps=Tb_P₁. (2) If Tb exceeds Tb_Dₖ due to an increase in the battery pack temperature and is within the range of Tb_Dₖ<Tb≤Tb_Dₖ₊₁, the control unit sets Ps=Tb_Pₖ₊₁, where k takes the values from 1 to N−1. For example, when N=5, k takes the values 1, 2, 3, and 4, specifically
\textcircled{1} When k=1, if Tb exceeds Tb_D1 due to temperature rise and is within the range of Tb_D₁<Tb≤Tb_D₂, the control unit sets Ps=Tb_P₂.
\textcircled{2} When k=2, if Tb exceeds Tb_D₂ due to temperature rise and is within the range of Tb_D₂<Tb≤Tb_D₃, the control unit sets Ps=Tb_P₃.
\textcircled{3} When k=3, if Tb exceeds Tb_D₃ due to temperature rise and is within the range of Tb_D₃<Tb≤Tb_D₄, the control unit sets Ps=Tb_P₄.
\textcircled{4} When k=4, if Tb exceeds Tb_D₄ due to temperature rise and is within the range of Tb_D₄<Tb≤Tb_D₅, the control unit sets Ps=Tb_P₅.

Those skilled in the art can deduce the corresponding relationship between Tb and Ps when N takes other values based on the above description.

In the model Mbat provided in this embodiment, the critical decision point temperatures and decision powers of the battery pack are inversely proportional, therefore, as the temperature of the battery pack increases, its power will be gradually limited and reduced, which usually causes the battery pack to cool down due to the lower power. To address this, the inventors of the present invention propose the inventive concept of restoring higher power when the temperature of the battery pack drops to a lower range. However, with the development of related technologies, the inventors also recognize that when the battery pack's power is restored to a higher level, its temperature will typically increase over time, causing the battery pack's temperature to quickly rise to a higher range and trigger power limitations, leading to a reduction in power. The reduction in power causes the battery pack's temperature to decrease, which in turn triggers power recovery and increases the power again. This cycle repeats, causing the battery pack's power to fluctuate frequently and making the operation of the portable energy storage device unstable and prone to damage.

Therefore, while proposing the power recovery concept, the inventors of the present invention creatively introduce the concept of “hysteresis temperature threshold (defined as Tb_H)” to avoid overly frequent changes in the real-time allowable power of the battery pack. The logic for using the hysteresis temperature threshold is as follows:
2. If power recovery triggered by a decrease in the battery pack temperature is involved:
when Tb decreases from a temperature higher than Tb_Dₖ₊₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2. For example, when N=5, k takes the values 1, 2, 3, specifically:
\textcircled{1} When k=1, if Tb decreases from a temperature higher than Tb_D₂ to (Tb_D₂−Tb_H₂) and falls within the range of (Tb_D₁−Tb_H₁)<Tb≤(Tb_D₂−Tb_H₂), the control unit sets Ps=Tb_P₂.
\textcircled{2} When k=2, if Tb decreases from a temperature higher than Tb_D₃ to (Tb_D₃−Tb_H₃) and falls within the range of (Tb_D₂−Tb_H₂)<Tb≤(Tb_D₃−Tb_H₃), the control unit sets Ps=Tb_P₃.
\textcircled{3} When k=3, if Tb decreases from a temperature higher than Tb_D₄ to (Tb_D₄−Tb_H₄) and falls within the range of (Tb_D₃−Tb_H₃)<Tb≤(Tb_D₄−Tb_H₄), the control unit sets Ps=Tb_P₄.

Those skilled in the art can deduce the corresponding relationship between Tb and Ps when N takes other values based on the above description.

To prevent damage to the battery pack caused by excessive temperature, this embodiment also includes an over-temperature protection function. Specifically, when the battery pack temperature exceeds a preset threshold, all charging and discharging functions of the battery pack are disabled. After being disabled, if the battery pack gradually cools down to a preset level, the charging and discharging functions are restored, and the corresponding power is allocated based on the temperature value at the time of restoration. Specifically:
when Tb exceeds Tb_D_{N}, the control unit disables the charging and discharging functions of the battery pack; when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N. Here, the critical decision point temperature that is that is the closest to and greater than or equal to (Tb_D_{N}−Tb_H_{N}) refers to the critical decision point temperature that immediately follows (Tb_D_{N}−Tb_H_{N}) when all critical decision point temperatures and (Tb_D_{N}−Tb_H_{N}) are sorted in ascending order. If a=1, satisfying Tb_min≤(Tb_D_{N}−Tb_H_{N})≤Tb_D₁, and the control unit restores the charging and discharging functions of the battery pack and sets Ps=Tb_P₁. If a=2, satisfying Tb_D₁< (Tb_D_{N}−Tb_H_{N})≤Tb_D₂, and the control unit restores the charging and discharging functions of the battery pack and sets Ps=Tb_P₂ . . . . If a=N, satisfying Tb_D_{N-1}< (Tb_D_{N}−Tb_H_{N})<Tb_D_{N}, and the control unit restores the charging and discharging functions of the battery pack and sets Ps=Tb_P_{N}.

Through the aforementioned design, it can be observed that during normal use of the battery, when Tb decreases to a critical decision point temperature such as Tb_D₃, the power is not immediately restored to Tb_P₃. Instead, the control unit still sets Ps=Tb_P₄ until Tb decreases to (Tb_D₃−Tb_H₃), at which point the power is restored to Tb_P₃. Similarly, when Tb decreases to Tb_D₂, the power is not immediately restored to Tb_P₂. Instead, the control unit still sets Ps=Tb_P₃ until Tb decreases to (Tb_D₂−Tb_H₂), at which point the power is restored to Tb_P₂. In other words, when the battery pack's power recovery is triggered by its temperature decrease, the power is not restored immediately upon reaching the critical decision point temperature. Instead, it requires the temperature value to reach the critical decision point temperature minus the hysteresis temperature threshold, thereby delaying the power recovery time. This ensures more stable power output and avoids frequent power adjustments caused by the battery pack's real-time temperature fluctuating near the critical decision point temperature. Furthermore, when the battery pack temperature exceeds the preset value, this embodiment disables the charging and discharging functions of the battery pack. To restart the battery pack, it is not sufficient for the temperature to drop below the aforementioned preset value; it must decrease to a value equivalent to the last critical decision point temperature Tb_D_{N} minus its corresponding hysteresis temperature threshold Tb_H_{N}. Additionally, it is particularly emphasized that in this embodiment, Tb_H_{N} can be either≤(Tb_D_{N}−Tb_D_{N-1}) or > (Tb_D_{N}−Tb_D_{N-1}), with the latter being preferable.

To further enhance the understanding of the aforementioned technical solution for dynamically adjusting the real-time allowable power based on the real-time temperature of the battery pack, the following explanation is provided with specific numerical values:

Assume that the battery pack model Mbat has 4 critical decision point temperatures with gradually increasing values. The corresponding decision powers and hysteresis temperature thresholds are shown in Table 1 below:

TABLE 1

| | | | | |
|---|---|---|---|---|
| Critical Decision Point | Tb_ D₁ = 10° C. | Tb_D₂ = 20° C. | Tb_D₃ = 40° C. | Tb_D₄ = 45° C. |
| Temperature | | | | |
| Decision Power | Tb_P₁ = 100 W | Tb_P₂ = 80 W | Tb_P₃ = 50 W | Tb_P₄ = 30 W |
| Hysteresis Temperature | Tb_H₁ = 5° C. | Tb_H₂ = 5° C. | Tb_H₃ = 10° C. | Tb_H₄ = 15° C. |
| Thresholds | | | | |

When the portable energy storage device provided in this embodiment is in use, assuming that the initial real-time temperature Tb of the battery pack is 8° C. due to cold weather or other reasons, since Tb<Tb_D₁ (10° C.), the control unit sets the real-time allowable power Ps of the battery pack to Tb_P₁, which is 100 W. If the real-time temperature of the battery pack remains within the range of Tb_min≤Tb≤Tb_D₁ (10° C.), the control unit maintains Ps at 100 W.

However, if after operating at 100 W for some time, the first temperature sensor feeds back to the control unit that the real-time temperature Tb of the battery pack exceeds Tb_D₁ (10° C.), the control unit adjusts the real-time allowable power Ps of the battery pack from Tb_P₁ (100 W) to Tb_P₂ (80 W). If the real-time temperature of the battery pack remains within the range of Tb_D₁ (10° C.)<Tb≤Tb_D₂ (20° C.), the control unit maintains Ps at Tb_P₂ (80 W). However, if after operating at 80 W for some time, the first temperature sensor feeds back to the control unit that the real-time temperature Tb of the battery pack decreases to Tb_D₁ (10° C.), the control unit does not immediately restore the real-time allowable power Ps of the battery pack to Tb_P₁ (100 W). Instead, it continues to wait. If the battery pack continues to cool down and the first temperature sensor feeds back to the control unit that the real-time temperature Tb of the battery pack decreases to (Tb_D₁−Tb_H₁), which is 5° C., the control unit restores the real-time allowable power Ps of the battery pack to Tb_P₁ (100 W). If after operating at 100 W for some time, the first temperature sensor feeds back to the control unit that the real-time temperature Tb of the battery pack exceeds Tb_D₁ (10° C.), the control unit adjusts the real-time allowable power Ps of the battery pack from Tb_P₁ (100 W) to Tb_P₂ (80 W).

If after operating at 80 W for some time, the first temperature sensor feeds back to the control unit that the real-time temperature Tb of the battery pack exceeds Tb_D₂ (20° C.), the control unit adjusts the real-time allowable power Ps of the battery pack from Tb_P₂ (80 W) to Tb_P₃ (50 W). If the real-time temperature of the battery pack remains within the range of Tb_D₂ (20° C.)<Tb≤Tb_D₃ (40° C.), the control unit maintains Ps at 50 W. However, if after operating at 50 W for some time, the first temperature sensor feeds back to the control unit that the real-time temperature Tb of the battery pack decreases to Tb_D₂ (20° C.), the control unit does not immediately restore the real-time allowable power Ps of the battery pack to Tb_P₂ (80 W). Instead, it continues to wait. If the battery pack continues to cool down and the first temperature sensor feeds back to the control unit that the real-time temperature Tb of the battery pack decreases to (Tb_D₂−Tb_H₂), which is below 15° C., the control unit restores the real-time allowable power Ps of the battery pack to Tb_P₂ (80 W). If after operating at 80 W for some time, the first temperature sensor feeds back to the control unit that the real-time temperature Tb of the battery pack exceeds Tb_D₂ (20° C.), the control unit adjusts the real-time allowable power Ps of the battery pack from Tb_P₂ (80 W) to Tb_P₃ (50 W).

If the temperature of the battery pack continues to rise and exceeds Tb_D₄ (45° C.), the control unit disables all charging and discharging functions of the battery pack and waits for the battery pack to cool down. If the battery pack cools down to Tb_D₄ (45° C.), the control unit does not immediately restore the charging and discharging functions of the battery pack. Instead, it continues to wait until the battery pack temperature decreases to (Tb_D₄-Tb_H₄), which is 30° C., at which point the control unit restores the charging and discharging functions of the battery pack and sets the power of the battery pack to Tb_P₃ (50 W). If after operating at 50 W for some time, the temperature of the battery pack exceeds Tb_D₃ (40° C.), the control unit adjusts the power of the battery pack from Tb_P₃ to Tb_P₄ (30 W). If after operating at 30 W for some time, the temperature of the battery pack decreases to Tb_D₃ (40° C.), the control unit does not immediately restore the real-time allowable power Ps of the battery pack to Tb_P₃ (50 W). Instead, it continues to wait. If the battery pack continues to cool down and the first temperature sensor feeds back to the control unit that the real-time temperature Tb of the battery pack decreases to (Tb_D₃−Tb_H₃), which is below 30° C., the control unit restores the real-time allowable power Ps of the battery pack to Tb_P₃ (50 W).

Through the above design, this embodiment ensures that the total allowable power of the battery pack can be adjusted according to its real-time temperature, maintaining the safety of the battery pack while keeping its allowable power at a high level. Additionally, the design of the hysteresis temperature threshold enhances the operational stability of the battery pack.

Furthermore, the specific scheme for adjusting the power of each channel in this application is as follows, where Tc refers to the real-time temperature of the corresponding channel detected by the second temperature sensor, Pc is the real-time allowable allocated power of the channel decided by the control unit, Ps is the real-time allowable total power of the battery pack at this time (which is determined based on the real-time temperature of the battery pack), and Tc_min is the minimum value of the allowable operating temperature range of the power channel:
1. If power recovery triggered by a decrease in the battery pack temperature is not involved:
(1) if Tc is within the range of Tc_min≤Tc≤Tc_D₁, the control unit sets Pc=MIN{Tc_P₁, (Ps−total power allocated to other channels)};
(2) if Tc exceeds Tc_Dₖ due to temperature rise and is within the range of Tc_D₁<Tc≤Tc_D₂, the control unit sets Pc=MIN{Tc_P₂, (Ps−total power allocated to other channels)}, where k takes the values from 1 to n−1. For example, when n=5, k takes the values 1, 2, 3, and 4, specifically:

\textcircled{1} When k=1, if Tc exceeds Tc_D₁ due to temperature rise and is within the range of Tc_D₁<Tc≤Tc_D₂, the control unit sets Pc=MIN{Tc_P₂, (Ps−total power allocated to other channels)}.
\textcircled{2} When k=2, if Tc exceeds Tc_D₂ due to temperature rise and is within the range of Tc_D₂<Tc≤Tc_D₃, the control unit sets Pc=MIN{Tc_P₃, (Ps−total power allocated to other channels)}.
\textcircled{3} When k=3, if Tc exceeds Tc_D₃ due to temperature rise and is within the range of Tc_D₃<Tc≤Tc_D₄, the control unit sets Pc=MIN{Tc_P₄, (Ps−total power allocated to other channels)}.
\textcircled{4} When k=4, if Tc exceeds Tc_D₄ due to temperature rise and is within the range of Tc_D₄<Tc≤Tc_D₅, the control unit sets Pc=MIN{Tc_P₅, (Ps−total power allocated to other channels)}.

Those skilled in the art can deduce the corresponding relationship between Tc and Pc when n takes other values based on the above description.
2. when power recovery triggered by a temperature decrease in the power channel is involved:
(1) if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, (Ps−total power allocated to other channels)}, where k takes values from 1 to n−2. For example, when n=5, k takes the values 1, 2, 3, and 4, specifically:
\textcircled{1} When k=1, if Tc decreases from a temperature higher than Tc_D₂ to (Tc_D₂−Tc_H₂) and falls within the range of (Tc_D₁−Tc_H₁)<Tc≤(Tc_D₂−Tc_H₂), the control unit sets Pc=MIN{Tc_P₂, (Ps−total power allocated to other channels)}.
\textcircled{2} When k=2, if Tc decreases from a temperature higher than Tc_D₃ to (Tc_D₃−Tc_H₃) and falls within the range of (Tc_D₂−Tc_H₂)<Tc≤(Tc_D₃−Tc_H₃), the control unit sets Pc=MIN{Tc_P₃, (Ps−total power allocated to other channels)}.
\textcircled{3} When k=3, if Tc decreases from a temperature higher than Tc_D₄ to (Tc_D₄−Tc_H₄) and falls within the range of (Tc_D₃−Tc_H₃)<Tc≤(Tc_D₄−Tc_H₄), the control unit sets Pc=MIN{Tc_P₄, (Ps−total power allocated to other channels)}.

Those skilled in the art can deduce the corresponding relationship between Tc and Pc when n takes other values based on the above description.

To prevent damage to the power channel caused by excessive temperature, this embodiment also includes an over-temperature protection function. Specifically, when the power channel temperature exceeds a preset threshold, its charging/discharging function are disabled. After being disabled, if the power channel gradually cools down to the preset level, the charging/discharging function of the power channel will be restored and the power will be allocated according to the current temperature of the power channel. Specifically:

when Tc exceeds Tc_Dₙ, the control unit disables the charging/discharging function of the power channel; when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, (Ps−total power allocated to other channels)}, where 1≤a≤n. Here, the critical decision point temperature that is that is the closest to and greater than or equal to (Tc_Dₙ−Tc_Hₙ) refers to the critical decision point temperature that immediately follows (Tc_Dₙ−Tc_Hₙ) when all critical decision point temperatures and (Tc_Dₙ−Tc_Hₙ) are sorted in ascending order. If a=1, when Tc_min≤(Tc_Dₙ−Tc_Hₙ)≤Tc_D₁, the control unit restores the charging/discharging function of the power channel and sets Pc=MIN{Tc_P₁, (Ps−total power allocated to other channels)}. If a=2, when Tc_D₁< (Tc_Dₙ−Tc_Hₙ)≤Tc_D₂, the control unit restores the charging/discharging function of the power channel and sets Pc=MIN{Tc_P₂, (Ps−total power allocated to other channels)} . . . . If a=n, when Tc_Dₙ−1< (Tc_Dₙ−Tc_Hₙ)≤Tc_Dₙ, the control unit restores the charging/discharging function of the power channel and sets Pc=MIN{Tc_Pₙ, (Ps−total power allocated to other channels)}.

It can be observed that when Tc decreases to a critical decision point temperature such as Tc_D₃, the power is not immediately restored to Tc_P₃. Instead, the control unit maintains Pc=Tc_P₄ until Tc further decreases to (Tc_D₃−Tc_H₃), at which point the power is restored to Tc_P₃. Similarly, when Tc decreases to Tc_D₂, the power is not immediately restored to Tc_P₂. The control unit keeps Pc=Tc_P₃ until Tc drops to (Tc_D₂−Tc_H₂), after which the power is restored to Tc_P₂. In other words, when power recovery is triggered by a temperature decrease in the power channel, the corresponding power is not restored immediately upon reaching the critical decision point temperature. Instead, the temperature must decrease to (critical decision point temperature minus hysteresis temperature threshold), thereby extending the time for power recovery. This ensures more stable power output and avoids frequent power adjustments caused by the real-time temperature of the power channel fluctuating near the critical decision point temperature. Additionally, it is particularly emphasized that in this embodiment, Tc_Hₙ can be either≤(Tc_Dₙ−Tc_Dₙ₋₁) or > (Tc_Dₙ−Tc_Dₙ₋₁), with the latter being preferable.

To further enhance understanding of the aforementioned technical solution for dynamically adjusting the real-time allowable power based on the real-time temperature of the power channel, the following explanation is provided with specific numerical values:

Assume the power channel is Channel 1, and its model Mn has four critical decision point temperatures with gradually increasing values. The corresponding decision powers and hysteresis temperature thresholds are shown in Table 2 below:

TABLE 2

| | | | | |
|---|---|---|---|---|
| Critical Decision | Tc_D₁ = 10° C. | Tc_D₂ = 20° C. | Tc_D₃ = 40° C. | Tc_D₄ = 45° C. |
| Point Temperature | | | | |
| Decision Power | Tc_P₁ = 50 W | Tc_P₂ = 40 W | Tc_P₃ = 30 W | Tc_P₄ = 10 W |
| Hysteresis | Tc_H₁ = 5° C. | Tc_H₂ = 5° C. | Tc_H₃ = 10° C. | Tc_H₄ = 15° C. |
| Temperature | | | | |
| Thresholds | | | | |

In this embodiment, when the portable energy storage device is in use, assuming the initial real-time temperature Tc of the power channel is 8° C. due to cold weather, where Tc<Tc_D1 (10° C.), the control unit sets the real-time allowable power Pc1 of this power channel to the smaller of the following two values: Tc_P1 (50 W) and (the real-time allowable total power of the battery pack at this time minus the total power allocated to other channels). If the power channel's real-time temperature remains within Tc_min≤Tc≤Tc_D1 (10° C.) thereafter, the control unit maintains the channel's power at Pc1.

However, if after operating at power level Pc1 for a period of time, the second temperature sensor feeds back to the control unit that the real-time temperature Tc of the power channel exceeds Tc_D₁ (10° C.), the control unit adjusts the real-time allowable power Pc of the channel from Pc1 to Pc2, where Pc2 is the smaller value between Tc_P₂ (40 W) and (the battery pack's current real-time allowable total power minus the total power allocated to other channels). If thereafter the channel's real-time temperature remains within the range Tc_D₁ (10° C.)<Tc≤Tc_D₂ (20° C.), the control unit maintains Pc2 unchanged. However, if after operating at power level Pc2 for some time, the second temperature sensor feeds back to the control unit that the real-time temperature Tc of the power channel decreases to Tc_D1 (10° C.), the control unit does not immediately restore the real-time allowable power Pc of the power channel to Pc1. Instead, it continues to wait. If the power channel continues to cool down and the second temperature sensor feeds back to the control unit that the real-time temperature Tc of the power channel decreases to (Tc_D₁−Tc_H₁), which is below 5° C., the control unit restores the real-time allowable power Pc of the power channel to Pc1. If after operating at power level Pc1 for some time, the second temperature sensor feeds back to the control unit that the real-time temperature Tc of the power channel exceeds Tc_D₁ (10° C.), the control unit adjusts the real-time allowable power Pc from Pel to Pc2.

If after operating at power level Pc2 for a period of time, the second temperature sensor feeds back to the control unit that the real-time temperature Tc of the power channel exceeds Tc_D₂ (20° C.), the control unit adjusts the real-time allowable power Pc of the power channel from Pc2 to Pc3, where Pc3 is the smaller value between Tc_P₃ (30 W) and (the battery pack's current real-time allowable total power minus the total power allocated to other channels). If thereafter the power channel's real-time temperature remains within the range Tc_D₂ (20° C.)<Tc≤Tc_D₃ (40° C.), the control unit maintains Pc3 unchanged. However, if after operating at power level Pc3 for some time, the second temperature sensor feeds back to the control unit that the real-time temperature Tc of the power channel decreases to Tc_D₂ (20° C.), the control unit does not immediately restore the real-time allowable power Pc of the power channel to Pc2. Instead, it continues to wait. If the power channel continues to cool down and the second temperature sensor feeds back to the control unit that the real-time temperature Tc of the power channel decreases to (Tc_D₂−Tc_H₂), which is below 15° C., the control unit restores the real-time allowable power Pc of the power channel to Pc2. If after operating at power level Pc2 for some time, the second temperature sensor feeds back to the control unit that the real-time temperature Tc of the power channel exceeds Tc_D₂ (20° C.), the control unit adjusts the real-time allowable power Pc from Pc2 to Pc3.

If the temperature of the power channel continues to rise and exceeds Tc_D₄ (45° C.), the control unit disables the charging/discharging function of the power channel and waits for the power channel to cool down. If the power channel cools down to Tc_D₄ (45° C.), the control unit does not immediately restore the charging/discharging function of the power channel. Instead, it continues to wait until the power channel's temperature decreases to (Tc_D₄−Tc_H₄), which is 30° C., at which point the control unit restores the charging/discharging function of the power channel and sets the power of the power channel to Pc3, where Pc3 is the smaller value between Tc_P3 (30 W) and (the battery pack's current real-time allowable total power minus the total power allocated to other channels). If after operating at power level Pc3 for some time, the temperature of the power channel exceeds Tc_D3, the control unit adjusts the power of the power channel to Pc4, where Pc4 is the smaller value between Tc_P4 (10 W) and (the power channel's current real-time allowable total power minus the total power allocated to other channels). If after operating at power level Pc4 for some time, the temperature of the power channel decreases to Tc_D3, the control unit does not immediately restore the real-time allowable power of the power channel to Tc_P3. Instead, it continues to wait. If the power channel continues to cool down and the second temperature sensor feeds back to the control unit that the real-time temperature Tc of the power channel decreases to (Tc_D₃−Tc_H₃), which is below 30° C., the control unit restores the real-time allowable power of the power channel to Pc3. If during operation the temperature of this power channel exceeds Tc_D₄ (45° C.) again, the control unit disables the charging/discharging function of the power channel and waits for it to cool down.

It should be noted that since the priority of the battery pack model Mbat is higher than that of the power channel model Mn, if the battery pack's entire charging and discharging functions are shut down due to its temperature exceeding the last critical decision point temperature, then regardless of the power channel's temperature, its charging/discharging function will also remain disabled.

Through the above design, this embodiment enables the sub-power of the power channel to adjust according to the real-time temperature of the power channel. This ensures the operational safety of the power channel while maintaining its power at a high level. Additionally, by incorporating the hysteresis temperature threshold design, the operation of the power channel achieves greater stability.

### Embodiment 2

This embodiment provides a portable energy storage device that dynamically adjusts power based on internal temperature. Its structure is similar to that of the portable energy storage device provided in Embodiment 1, and the relevant power allocation rules are also comparable. For identical aspects, this embodiment will not reiterate them. The following highlights only the differences:

In the temperature model Mbat of the battery pack in this embodiment, the number of critical decision point temperatures is 2 (i.e., N=2). Similarly, in the temperature model Mn of the power channel, the number of critical decision point temperatures is also 2 (i.e., n=2). Thus:
when power recovery triggered by a temperature decrease in the battery pack is not involved: if Tb is within the range of Tb_min≤Tb≤Tb_D₁, the control unit sets Ps=Tb_P₁; if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved: if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack; when Tb decreases from a temperature higher than Tb_D₂ to (Tb_D₂−Tb_H₂), Tb_Dₐ is defined the critical decision point temperature that is the closest to and greater than or equal to (Tb_D₂−Tb_H₂), if Tb_Dₐ is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.

And,
when power recovery triggered by a temperature decrease in the power channel is not involved: if Tc is within the range of Tc_min≤Tc≤Tc_D₁, the control unit sets Pc=MIN{Tc_P₁, (Ps−total power allocated to other channels)}; if Tc exceeds Tc_D₁ due to temperature rise and is within the range of Tc_D₁<Tc≤Tc_D₂, the control unit sets Pc=MIN{Tc_P₂, (Ps−total power allocated to other channels)};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, (Ps−total power allocated to other channels)};
when Tc exceeds Tc_D₂ due to temperature rise, the control unit disables the charging and discharging functions of the power channel; when Tc decreases from a temperature higher than Tc_D₂ to (Tc_D₂−Tc_H₂), define the critical decision point temperature that is the closest to and greater than or equal to (Tc_D₂−Tc_H₂) as Tc_Da, if Tc_Da is Tc_D₁, the control unit restores the charging/discharging function of the power channel and sets Pc=MIN{Tc_P1, (Ps−total power allocated to other channels)}, if Tc_Da is Tc_D₂, the control unit restores the charging/discharging function of the power channel and sets Pc=MIN{Tc_P₂, (Ps−total power allocated to other channels)}.

### Embodiment 3

This embodiment provides a portable energy storage device that dynamically adjusts power based on internal temperature. Its structure is similar to those of the portable energy storage devices described in Embodiment 1 and Embodiment 2, which also dynamically adjust power based on internal temperature. The related power allocation rules are likewise comparable. For the identical aspects, this embodiment will not reiterate them, and only the differences are highlighted below:

In this embodiment, there is only one power channel. After the battery pack obtains the allowable total power according to the rules specified in Embodiment 1, since there is only one power channel, the corresponding allowable power is determined by taking the smaller value between the decision power corresponding to its temperature, and the allocated sub-power from the system. Here, the allocated sub-power from the system=the real-time total allowable power of the battery pack.

That is,
when n≥3,
when power recovery triggered by a temperature decrease in the power channel is not involved: if Tc is within the range of Tc_min≤Tc≤Tc_D₁, the control unit sets Pc=MIN{Tc_P₁, Ps}; if Tc exceeds Tc_Dₖ due to temperature rise and is within the range of Tc_Dₖ<Tc≤Tc_Dₖ₊₁, the control unit sets Pc=MIN{Tc_Pₖ₊₁, Ps}, where k takes values from 1 to n−1;
when power recovery triggered by a temperature decrease in the power channel is involved: if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, Ps}, where k takes values from 1 to n−2; if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_Dₙ, the control unit disables the charging/discharging function of the power channel; when Tc decreases from a temperature higher than Tc_Dn to (Tc_Dn−Tc_Hn), define the critical decision point temperature that is the closest to and greater than or equal to (Tc_Dn−Tc_Hn) as Tc_Da, the control unit restores the charging/discharging function of the power channel and sets Pc=MIN{Tc_Pa, Ps}, where 1≤a≤n.
when n=2:
when power recovery triggered by a temperature decrease in the power channel is not involved: if Tc is within the range Tc_min≤Tc≤Tc_D₁, the control unit sets Pc=MIN{Tc_P₁, Ps}; if Tc exceeds Tc_D₁ due to temperature rise and is within the range of Tc_D₁<Tc≤Tc_D₂, the control unit sets Pc=MIN{Tc_P₂, Ps};
when power recovery triggered by a temperature decrease in the power channel is involved: if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_D₂ due to temperature rise, the control unit disables the charging and discharging functions of the power channel; when Tc decreases from a temperature higher than Tc_D₂ to (Tc_D₂−Tc_H₂), define the critical decision point temperature that is the closest to and greater than or equal to (Tc_D₂−Tc_H₂) as Tc_Da, if Tc_Da is Tc_D₁, the control unit restores the charging and discharging functions of the power channel and sets Pc=MIN{Tc_P₁, Ps}, if Tc_Da is Tc_D₂, the control unit restores the charging/discharging function of the power channel and sets Pc=MIN{Tc_P₂, Ps}.

### Embodiment 4

This embodiment provides a method for dynamically adjusting power based on internal temperature. Depending on the number of power channels and the values of N and n, this method is applicable to the portable energy storage devices described in Embodiments 1 to 3. For the structure of the portable energy storage device, refer to Embodiments 1 to 3, which will not be repeated here.
1. when the number of power channels is at least 2:
(1) when N≥3:
when power recovery triggered by a temperature decrease in the battery pack is not involved: if Tb is within the range of Tb_min≤Tb≤Tb_D₁, the control unit sets Ps=Tb_P₁; if Tb exceeds Tb_Dₖ due to temperature rise and is within the range of Tb_Dₖ<Tb≤Tb_Dₖ₊₁, the control unit sets Ps=Tb_Pₖ₊₁, where k takes values from 1 to N−1;
when power recovery triggered by a temperature decrease in the battery pack is involved: if Tb decreases from a temperature higher than Tb_Dₖ₊₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2; if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D_{N}, the control unit disables the charging and discharging functions of the battery pack; when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N;
if n≥3:
when power recovery triggered by a temperature decrease in the power channel is not involved: if Tc is within the range of Tc_min≤Tc≤Tc_D₁, the control unit sets Pc=MIN{Tc_P₁, (Ps−total power allocated to other channels)}; if Tc exceeds Tc Dₖ due to temperature rise and is within the range of Tc_Dₖ<Tc≤Tc_Dₖ₊₁, the control unit sets Pc=MIN{Tc_Pₖ₊₁, (Ps−total power allocated to other channels)}, where k takes values from 1 to n−1;
when power recovery triggered by a temperature decrease in the power channel is involved: if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, (Ps−total power allocated to other channels)}, where k takes values from 1 to n−2; if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, (Ps−total power allocated to other channels)};
when Tc exceeds Tc_Dₙ, the control unit disables the charging/discharging function of the power channel; when Tc decreases from a temperature higher than Tc_Dn to (Tc_Dn−Tc_Hn), define the critical decision point temperature that is the closest to and greater than or equal to (Tc_Dn−Tc_Hn) as Tc_Da, the control unit restores the charging/discharging function of the power channel and sets Pc=MIN{Tc_Pa, (Ps−total power allocated to other channels)}, where 1≤a≤n;
(2) when N=2:
when power recovery triggered by a temperature decrease in the battery pack is not involved: if Tb is within the range of Tb_min≤Tb≤Tb_D₁, the control unit sets Ps=Tb_P₁; if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved: if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack; when Tb decreases from a temperature higher than Tb_D₂ to (Tb_D₂−Tb_H₂), Tb_Dₐ is defined the critical decision point temperature that is the closest to and greater than or equal to (Tb_D₂−Tb_H₂), if Tb_Da is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.
when n=2:
when power recovery triggered by a temperature decrease in the power channel is not involved: if Tc is within the range of Tc_min≤Tc≤Tc_D₁, the control unit sets Pc=MIN{Tc_P₁, (Ps−total power allocated to other channels)}; if Tc exceeds Tc_D₁ due to temperature rise and is within the range of Tc_D₁<Tc≤Tc_D₂, the control unit sets Pc=MIN{Tc_P₂, (Ps−total power allocated to other channels)};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, (Ps−total power allocated to other channels)};
when Tc exceeds Tc_D₂ due to temperature rise, the control unit disables the charging and discharging functions of the power channel; when Tc decreases from a temperature higher than Tc_D₂ to (Tc_D₂−Tc_H₂), define the critical decision point temperature that is the closest to and greater than or equal to (Tc_D₂−Tc_H₂) as Tc_Da, if Tc_Da is Tc_D₁, the control unit restores the charging/discharging function of the power channel and sets Pc=MIN{Tc_P1, (Ps−total power allocated to other channels)}, if Tc_Da is Tc_D2, the control unit restores the charging/discharging function of the power channel and sets Pc=MIN{Tc_P2, (Ps−total power allocated to other channels)}.
2. when the number of power channels is at least one:
   (1) if N≥3:
when power recovery triggered by a temperature decrease in the battery pack is not involved: if Tb is within the range of Tb_min≤Tb≤Tb_D₁, the control unit sets Ps=Tb_P₁; if Tb exceeds Tb_Dₖ due to temperature rise and is within the range of Tb_Dₖ<Tb≤Tb_Dₖ₊₁, the control unit sets Ps=Tb_Pₖ₊₁, where k takes values from 1 to N−1;
when power recovery triggered by a temperature decrease in the battery pack is involved: if Tb decreases from a temperature higher than Tb_Dₖ₊₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2; if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D_{N}, the control unit disables the charging and discharging functions of the battery pack; when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N;
when n≥3:
when power recovery triggered by a temperature decrease in the power channel is not involved: if Tc is within the range of Tc_min≤Tc≤Tc_D₁, the control unit sets Pc=MIN{Tc_P₁, Ps}; if Tc exceeds Tc_Dₖ due to temperature rise and is within the range of Tc_Dₖ<Tc≤Tc_Dₖ₊₁, the control unit sets Pc=MIN{Tc_Pₖ₊₁, Ps}, where k takes values from 1 to n−1;
when power recovery triggered by a temperature decrease in the power channel is involved: if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, Ps}, where k takes values from 1 to n−2; if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_Dₙ, the control unit disables the charging/discharging function of the power channel; when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, Pₛ}, where 1≤a≤n;
   (2) If N=2:
when power recovery triggered by a temperature decrease in the battery pack is not involved: if Tb is within the range of Tb_min≤Tb≤Tb_D₁, the control unit sets Ps=Tb_P₁; if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved: if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack;
when Tb decreases from a temperature higher than Tb_D₂ to (Tb_D₂−Tb_H₂), Tb_Dₐ is defined as the critical decision point temperature that is the closest to and greater than or equal to (Tb_D₂−Tb_H₂), if Tb_Da is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.
when n=2:
when power recovery triggered by a temperature decrease in the power channel is not involved: if Tc is within the range of Tc_min≤Tc≤Tc_D₁, the control unit sets Pc=MIN{Tc_P₁, Ps}; if Tc exceeds Tc_D₁ due to temperature rise and is within the range of Tc_D₁<Tc≤Tc_D₂, the control unit sets Pc=MIN{Tc_P₂, Ps};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, Ps};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Dₐ, if Tc_Da is Tc_D₁, the control unit restores the charging/discharging function of the power channel and sets Pc=MIN{Tc_P₁, Ps}; if Tc_Dₐ is Tc_D₂, the control unit restores the charging/discharging function of the power channel and sets Pc=MIN{Tc_P₂, Ps}.

The specific embodiments of the present invention have been described above. Based on the explanations provided, relevant personnel can make various changes and modifications without departing from the scope of the technical concept of this invention.

1. A portable energy storage device that dynamically adjusts power based on internal temperature, wherein
the device comprises a battery pack, a first temperature sensor, and a control unit, the first temperature sensor is used to detect the real-time temperature of the battery pack, and the control unit can set the real-time allowable power of the battery pack based on the real-time temperature of the battery pack fed back by the first temperature sensor;
the control unit has a built-in pre-configured temperature model for the battery pack, defined as model Mbat, in model Mbat, N critical decision point temperatures with gradually increasing values are set, defined as Tb_D₁, Tb_D₂, . . . , Tb_D_{N}, and N decision powers with gradually decreasing values corresponding one-to-one to the critical decision point temperatures, defined as Tb_P₁, Tb_P₂, . . . , Tb_P_{N}, and N hysteresis temperature thresholds corresponding one-to-one to the decision powers, defined as Tb_H₁, Tb_H₂, . . . , Tb_H_{N}, Tb is defined as the real-time temperature of the battery pack, Ps is defined as the real-time allowable power of the battery pack decided by the control unit, and Tb_min is defined as the minimum value of the allowable operating temperature range of the battery pack, when N≥3:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_Dₖ due to temperature rise and is within the range of Tb_Dₖ<Tb≤Tb_Dₖ₊₁, the control unit sets Ps=Tb_Pₖ₊₁, where k takes values from 1 to N−1;
when power recovery triggered by a temperature decrease in the battery pack is involved:
if Tb decreases from a temperature higher than Tb_Dₖ₋₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2;
if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb Dx, the control unit disables the charging and discharging functions of the battery pack;
when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N.

2. The portable energy storage device according to claim 1, wherein
when N=2:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved:
if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack;
when Tb decreases from a temperature higher than Tb_D₂ to (Tb_D₂−Tb_H₂), Tb_Dₐ is defined as the critical decision point temperature that is the closest to and greater than or equal to (Tb_D₂−Tb_H₂), if Tb_Dₐ is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.

3. The portable energy storage device according to claim 1, wherein
the device further comprises at least two power channels and a corresponding number of second temperature sensors, with the second temperature sensors individually installed in the power channels to detect the real-time temperature of each power channel; the control unit can set the real-time allowable power of each power channel based on the real-time temperature of the power channel fed back by the second temperature sensors;
the control unit also has a built-in pre-configured temperature model for each power channel, defined as model Mn, in each model Mn, n critical decision point temperatures with gradually increasing values are set, defined as Tc_D₁, Tc_D₂, . . . , Tc_Dₙ, and n decision powers with gradually decreasing values corresponding one-to-one to the critical decision point temperatures, defined as Tc_P₁, Tc_P₂, . . . , Tc_Pₙ, and n hysteresis temperature thresholds corresponding one-to-one to the decision powers, defined as Tc_H₁, Tc_H₂, . . . , Tc_Hₙ; Tc is defined as the real-time temperature of any power channel, Pc is defined as the real-time allowable power of the channel decided by the control unit, and Tc_min is defined as the minimum value of the allowable operating temperature range of the channel; when n≥3:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_Dₖ due to temperature rise and is within the range of Tc_Dₖ<Tc≤Tc_Dₖ₊₁, the control unit sets Pc=MIN{Tc_Pₖ₊₁, (Ps−total power allocated to other channels)}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, (Ps−total power allocated to other channels)}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, (Ps−total power allocated to other channels)};
when Tc exceeds Tc_Dₙ, the control unit disables the charging/discharging function of the power channel;
when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, (Ps−total power allocated to other channels)}, where 1≤a≤n.

4. The portable energy storage device according to claim 3, wherein
when n=2:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_D₁ due to temperature rise and is within the range of Tc_D₁<Tc≤Tc_D₂, the control unit sets Pc=MIN{Tc_P₂, (Ps−total power allocated to other channels)};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, (Ps−total power allocated to other channels)};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Da, if Tc_Da is Tc_D₁, the control unit restores the charging/discharging function of the power channel and sets Pc=MIN{Tc_P₁, (Ps−total power allocated to other channels)}; if Tc_Da is Tc_D₂, the control unit restores the charging/discharging function of the power channel and sets Pc=MIN{Tc_P₂, (Ps−total power allocated to other channels)}.

5. The portable energy storage device according to claim 1, wherein
the device further comprises a power channel and a second temperature sensor, with the second temperature sensor installed in the power channel to detect the real-time temperature of the power channel; the control unit can set the real-time allowable power of the power channel based on the real-time temperature of the power channel fed back by the second temperature sensor;
the control unit also has a built-in pre-configured temperature model for the power channel, defined as model M1, in model M1, n critical decision point temperatures with gradually increasing values are set, defined as Tc_D₁, Tc_D₂, . . . , Tc_Dₙ, and n decision powers with gradually decreasing values corresponding one-to-one to the critical decision point temperatures, defined as Tc_P₁, Tc_P₂, . . . , Tc_Pₙ, and n hysteresis temperature thresholds corresponding one-to-one to the decision powers, defined as Tc_H₁, Tc_H₂, . . . , Tc_Hₙ; Tc is defined as the real-time temperature of the power channel, Pc is defined as the real-time allowable power of the channel decided by the control unit, and Tc_min is defined as the minimum value of the allowable operating temperature range of the channel; when n≥when power recovery triggered by a temperature decrease in the power channel is not involved:
if Tc is within the range of Tc_min≤Tc≤Tc_D₁, the control unit sets Pc=MIN{Tc_P₁, Ps};
if Tc exceeds Tc_Dₖ due to temperature rise and is within the range of Tc_Dₖ<Tc≤Tc_Dₖ₊₁, the control unit sets Pc=MIN{Tc_Pₖ₊₁, Ps}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, Ps}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_Dₙ, the control unit disables the charging/discharging function of the power channel;
when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pa, Ps}, where 1≤a≤n.

6. The portable energy storage device according to claim 5, wherein
when n=2:
when power recovery triggered by a temperature decrease in the power channel is not involved:
if Tc is within the range of Tc_min≤Tc≤Tc_D₁, the control unit sets Pc=MIN{Tc_P₁, Ps}; if Tc exceeds Tc_D₁ due to temperature rise and is within the range of Tc_D₁<Tc≤Tc_D₂, the control unit sets Pc=MIN{Tc_P₂, Ps};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, Ps};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Dₐ, if Tc_Dₐ is Tc_D₁, the control unit restores the charging/discharging function of the power channel and sets Pc=MIN{Tc_P₁, Ps}, if Tc_Dₐ is Tc_D₂, the control unit restores the charging/discharging function of the power channel and sets Pc=MIN{Tc_P₂, Ps}.

7. The portable energy storage device according to claim 1, wherein
when the power channel is a charging channel, the allowable power of the battery pack is the allowable input power; when the power channel is a discharging channel, the allowable power of the battery pack is the allowable output power.

8. The portable energy storage device according to claim 1, wherein
the device is internally equipped with a main control board and one or more independent circuit boards connected to the main control board; the circuit boards are provided with interfaces for charging/discharging, each interface corresponding to a power channel; the main control board is embedded with an intelligent control chip, and the control unit is implemented on the intelligent control chip.

9. The portable energy storage device according to claim 8, wherein
the control unit constructs a temperature variation curve by reading the voltage, current, temperature of the power channels, and the temperature of the battery pack from each interface, and adjusts the charging/discharging power of each interface accordingly.

10. A method for dynamically adjusting power based on internal temperature, wherein
the method is applied to the portable energy storage device according to claim 1, the method comprising a battery pack power adjustment method, wherein the battery pack power adjustment method is as follows:
when N≥3:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_Dₖ due to temperature rise and is within the range of Tb_Dₖ<Tb≤Tb_Dₖ₊₁, the control unit sets Ps=Tb_Pₖ₊₁, where k takes values from 1 to N−1;
when power recovery triggered by a temperature decrease in the battery pack is involved:
if Tb decreases from a temperature higher than Tb_Dₖ₊₁ to (Tb_Dₖ₊₁−Tb_Hₖ₊₁) and is within the range of (Tb_Dₖ−Tb_Hₖ)<Tb≤(Tb_Dₖ₊₁−Tb_Hₖ₊₁), the control unit sets Ps=Tb_Pₖ₊₁, where k takes values from 1 to N−2;
if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D_{N}, the control unit disables the charging and discharging functions of the battery pack;
when Tb decreases from a temperature higher than Tb_D_{N} to (Tb_D_{N}−Tb_H_{N}), Tb_Dₐ is defined as the critical decision point temperature that is the closest to and greater than or equal to (Tb_D_{N}−Tb_H_{N}), the control unit restores the charging and discharging functions of the battery pack and sets Ps=Tb_Pₐ, where 1≤a≤N;
when N=2:
when power recovery triggered by a temperature decrease in the battery pack is not involved:
if Tb is within the range of Tb_min≤Tb≤Tb_D₁, the control unit sets Ps=Tb_P₁;
if Tb exceeds Tb_D₁ due to temperature rise and is within the range of Tb_D₁<Tb≤Tb_D₂, the control unit sets Ps=Tb_P₂;
when power recovery triggered by a temperature decrease in the battery pack is involved: if Tb decreases from a temperature higher than Tb_D₁ to (Tb_D₁−Tb_H₁) and is within the range of Tb_min≤Tb≤(Tb_D₁−Tb_H₁), the control unit sets Ps=Tb_P₁;
when Tb exceeds Tb_D₂ due to temperature rise, the control unit disables the charging and discharging functions of the battery pack;
when Tb decreases from a temperature higher than Tb_D₂ to (Tb_D₂−Tb_H₂), Tb_Dₐ is defined as the critical decision point temperature that is the closest to and greater than or equal to (Tb_D₂−Tb_H₂), if Tb_Da is Tb_D₁, the control unit restores the charging and discharging functions of the battery pack and sets Ps=Tb_P₁; if Tb_Dₐ is Tb_D₂, the control unit restores the charging and discharging functions of the battery pack and sets Ps=Tb_P₂.

11. The method for dynamically adjusting power based on internal temperature according to claim 10, wherein
when the energy storage device further comprises at least two power channels, the method further comprises a power adjustment method for the power channels;
the control unit also has a built-in pre-configured temperature model for each power channel, defined as model Mn, in each model Mn, n critical decision point temperatures with gradually increasing values are set, defined as Tc_D₁, Tc_D₂, . . . , Tc_Dₙ, and n decision powers with gradually decreasing values corresponding one-to-one to the critical decision point temperatures, defined as Tc_P₁, Tc_P₂, . . . , Tc_Pₙ, and n hysteresis temperature thresholds corresponding one-to-one to the decision powers, defined as Tc_H₁, Tc_H₂, . . . , Tc_Hₙ; Tc is defined as the real-time temperature of any power channel, Pc is defined as the real-time allowable power of the channel decided by the control unit, and Tc_min is defined as the minimum value of the allowable operating temperature range of the channel;
when n≥3:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_Dₖ due to temperature rise and is within the range of Tc_Dₖ<Tc≤Tc_Dₖ₊₁, the control unit sets Pc=MIN{Tc_Pₖ₊₁, (Ps−total power allocated to other channels)}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, (Ps−total power allocated to other channels)}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, (Ps−total power allocated to other channels)};
when Tc exceeds Tc_Dₙ, the control unit disables the charging/discharging function of the power channel;
when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, (Ps−total power allocated to other channels)}, where 1≤a≤n;
when n=2:
when power recovery triggered by a temperature decrease in the power channel is not involved:
if Tc is within the range of Tc_min≤Tc≤Tc_D₁, the control unit sets Pc=MIN{Tc_P₁, (Ps−total power allocated to other channels)};
if Tc exceeds Tc_D₁ due to temperature rise and is within the range of Tc_D₁<Tc≤Tc_D₂, the control unit sets Pc=MIN{Tc_P₂, (Ps−total power allocated to other channels)};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, (Ps−total power allocated to other channels)};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Da, if Tc_Da is Tc_D₁, the control unit restores the charging/discharging function of the power channel and sets Pc=MIN{Tc_P₁, (Ps−total power allocated to other channels)}; if Tc_Da is Tc_D₂, the control unit restores the charging/discharging function of the power channel and sets Pc=MIN{Tc_P₂, (Ps−total power allocated to other channels)}.

12. The method for dynamically adjusting power based on internal temperature according to claim 10, wherein
when the energy storage device further comprises one power channel, the method further comprises a power adjustment method for the power channel;
the control unit also has a built-in pre-configured temperature model for the power channel, defined as model M1, in model M1, n critical decision point temperatures with gradually increasing values are set, defined as Tc_D₁, Tc_D₂, . . . , Tc_Dₙ, and n decision powers with gradually decreasing values corresponding one-to-one to the critical decision point temperatures, defined as Tc_P₁, Tc_P₂, . . . , Tc_Pₙ, and n hysteresis temperature thresholds corresponding one-to-one to the decision powers, defined as Tc_H₁, Tc_H₂, . . . , Tc_Hₙ; Tc is defined as the real-time temperature of the power channel, Pc is defined as the real-time allowable power of the channel decided by the control unit, and Tc_min is defined as the minimum value of the allowable operating temperature range of the channel;
when n≥3:
when power recovery triggered by a temperature decrease in the power channel is not involved:
if Tc is within the range of Tc_min≤Tc≤Tc_D₁, the control unit sets Pc=MIN{Tc_P₁, Ps};
if Tc exceeds Tc_Dₖ due to temperature rise and is within the range of Tc_Dₖ<Tc≤Tc_Dₖ₊₁, the control unit sets Pc=MIN{Tc_Pₖ₊₁, Ps}, where k takes values from 1 to n−1;
when power recovery triggered by a temperature decrease in the power channel is involved:
if Tc decreases from a temperature higher than Tc_Dₖ₊₁ to (Tc_Dₖ₊₁−Tc_Hₖ₊₁) and is within the range of (Tc_Dₖ−Tc_Hₖ)<Tc≤(Tc_Dₖ₊₁−Tc_Hₖ₊₁), the control unit sets Pc=MIN{Tc_Pₖ₊₁, Ps}, where k takes values from 1 to n−2;
if Tc decreases from a temperature higher than Tc_D₁ to (Tc_D₁−Tc_H₁) and is within the range of Tc_min≤Tc≤(Tc_D₁−Tc_H₁), the control unit sets Pc=MIN{Tc_P₁, Ps};
when Tc exceeds Tc_Dₙ, the control unit disables the charging/discharging function of the power channel; when Tc decreases from a temperature higher than Tc_Dₙ to (Tc_Dₙ−Tc_Hₙ), define the critical decision point temperature that is the closest to and greater than or equal to (Tc_Dₙ−Tc_Hₙ) as Tc_Dₐ, the control unit restores the charging/discharging function of the power channel and sets Pc=MIN{Tc_Pₐ, Pₛ}, where 1≤a≤n;
when n=2:
when power recovery triggered by a temperature decrease in the power channel is not involved:
if Tc is within the range of Tc_min≤Tc≤Tc_D₁, the control unit sets Pc=MIN{Tc_P₁, Ps};
if Tc exceeds Tc_D₁ due to temperature rise and is within the range of Tc_D₁<Tc≤Tc_D₂, the control unit sets Pc=MIN{Tc_P₂, Ps};
when power recovery triggered by a temperature decrease in the power channel is involved: if Tc decreases from a temperature higher than Tc_D₁ to the range of Tc_min≤Tc≤Tc_D₁, the control unit sets Pc=MIN{Tc_P₁, Ps};
when Tc exceeds Tc_D₂ due to temperature rise, the control unit disables the charging and discharging functions of the power channel;
when Tc decreases from a temperature higher than Tc_D₂ to (Tc_D₂−Tc_H₂), define the critical decision point temperature that is the closest to and greater than or equal to (Tc_D₂−Tc_H₂) as Tc_Dₐ, if Tc_Dₐ is Tc_D₁, the control unit restores the charging/discharging function of the power channel and sets Pc=MIN{Tc_P₁, Ps}; if Tc_Dₐ is Tc_D₂, the control unit restores the charging/discharging function of the power channel and sets Pc=MIN{Tc_P₂, Ps}.
